(19) United States
(12) Patent Application Publication
(10) Pub. No.: US 2006/0270414 A1
(43) Pub. Date: Nov. 30, 2006

(54) Apparatus and method for resource allocation in a wireless network

(75) Inventors: Jey Veerasamy, Richardson, TX (US); Vijayasimman Rajasimman, Garland, TX (US); Chanakya Bandyopadhyay, Richardson, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/409,726

(22) Filed: Apr. 24, 2006

Related U.S. Application Data
(60) Provisional application No. 60/685,444, filed on May 27, 2005.

(51) Int. Cl. H04Q 7/20

(52) U.S. Cl. 455/452.1; 455/453

(57) ABSTRACT

A base station capable of dynamic resource allocation. The base station comprises a plurality of transmission lines connecting a base station controller can a base transceiver subsystem and a resource manager capable of allocating loads to the plurality of transmission lines based at least partially on performance data of individual ones of the plurality of transmission lines. A base transceiver subsystem capable of dynamic resource allocation, said base transceiver subsystem. The base transceiver subsystem comprises a plurality of channel elements for performing bi-directional communications with a mobile station and a resource manager capable of allocating loads to the plurality of channel elements based at least partially on performance data of individual ones of the plurality of channel elements.

### CROSS-REFERENCE TO RELATED APPLICATION AND CLAIM OF PRIORITY

The present application is related to U.S. Provisional Patent No. 60/685,444, filed May 27, 2005, entitled “Intelligent Resource Allocation In Wireless Networks Through Self-Learning”. U.S. Provisional Patent No. 60/685,444 is assigned to the assignee of the present application and is hereby incorporated by reference into the present disclosure as if fully set forth herein. The present application hereby claims priority under 35 U.S.C. §119(e) to U.S. Provisional Patent No. 60/685,444.

### TECHNICAL FIELD OF THE INVENTION

The present application relates generally to wireless telecommunications and, more specifically, to a resource allocation in a wireless network.

### BACKGROUND OF THE INVENTION

In any wireless system, resource allocation is important for providing overall quality of service. As call requests are made and received, resources must be selected and allocated to each call in such a way that the greatest number of calls can be handled efficiently and effectively.

One common resource allocation technique is a “round-robin” allocation scheme, in which individual resources are each allocated in turn in order to balance the incoming load. This simple allocation scheme works best when resources are utilized for approximately fixed durations. For example, when there are multiple channel cards supporting calls in a wireless network base station, calls may be allocated to a channel card using a round-robin scheme. This solution is seldom ideal because resource utilization times vary widely, so that a pure round-robin scheme results in uneven utilization of resources.

Another common resource allocation technique is a “least loaded” allocation scheme, in which every incoming load is assigned to the currently least-loaded resource. For example, when there are multiple connections, such as T1 transmission lines, from a base station controller (BSC) to a base transceiver subsystem (BTS), a newly arriving call may be allocated to the least-loaded connection. This scheme ensures that all connections are approximately equally loaded.

Other common resource allocation techniques include a mixed allocation scheme, where a combination of the above two schemes is used. For example, a newly arriving call may be allocated a frame offset using a round-robin scheme and then assigned to the least-loaded T1 connection within that frame offset.

While these known techniques may be used even when a resource fails completely (i.e., by removing that resource from use), these techniques do not account for resources that are underperforming or experiencing errors. Particular problems arise when a fault management system is unable to detect failure of a resource, causing all calls allocated to the resource to fail as well. In these cases, calls continue to be routed to failing or underperforming resources.

Additionally, in some cases, the failing resource may cause some or all calls to be dropped, making the resource appear as the least-loaded resource some or all of the time. This problem results in even more calls being allocated to the resource, which calls are then similarly dropped.

Therefore, there is a need in the art for apparatuses and methods for resource allocation in a wireless network.

### SUMMARY OF THE INVENTION

One disclosed embodiment includes a base station capable of dynamic resource allocation. The base station comprises a plurality of transmission lines connecting a base station controller and a base transceiver subsystem and a resource manager capable of allocating loads to the plurality of transmission lines based at least partially on performance data of individual ones of the plurality of transmission lines.

Another disclosed embodiment includes a base transceiver subsystem capable of dynamic resource allocation. The base transceiver subsystem comprises a plurality of channel elements for performing bi-directional communications with a mobile station and a resource manager capable of allocating loads to the plurality of channel elements based at least partially on performance data of individual ones of the plurality of channel elements.

Another disclosed embodiment includes a network, comprising a plurality of resources, each resource capable of servicing at least one load and a resource manager capable of dynamically allocating loads to the plurality of resources based at least partially on performance data of individual ones of the plurality of resources.

Another disclosed embodiment includes a method for resource allocation. The method comprises receiving performance data for a plurality of resources, assigning a weight to at least one of the plurality of resources based on the performance data, and allocating a load to at least one of the plurality of resources according to the assigned weight.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network according to an exemplary embodiment of the disclosure;

FIG. 2 illustrates a base station in greater detail according to an exemplary embodiment of the disclosure; and

FIG. 3 illustrates a flowchart of a process according. to an exemplary embodiment of the disclosure.

### DETAILED DESCRIPTION OF THE INVENTION

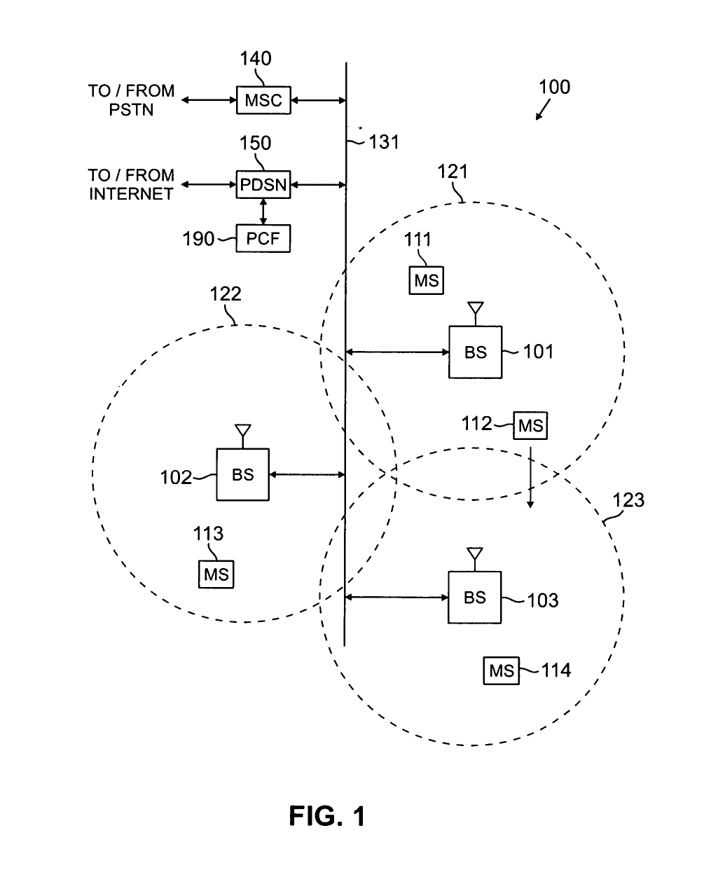

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

Disclosed embodiments include apparatuses and methods for intelligent resource allocation in a wireless network. Depending on the resource being managed, different parts of the wireless network may be modified to implement the disclosed embodiments. The descriptions below include modifications to various components of the wireless network for managing different resources. As will be apparent to those of skill in the art, not all modifications need be made in every case. Indeed, only those modifications necessary to manage specific resources in accordance with the disclosed embodiments need be made in any specific implementation. In these cases, the remainder of the wireless network can be implemented in a conventional manner.

FIG. 1 illustrates exemplary wireless network 100, in which resources may be allocated according to the principles of the present disclosure. Wireless network 100 comprises a plurality of cells (or cell sites) 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present disclosure, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present disclosure is not limited to mobile devices. The present disclosure also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cells (or cell sites) 121-123 in which base stations 101-103 are located. It is noted that the terms “cells” and “cell sites” may be used interchangeably in common practice. For simplicity, the term “cell” will be used hereafter. The cells are shown approximately circular for the purposes of illustration and explanation only. It should be clearly understood that the cells may have other irregular shapes, depending on the cell configuration selected and variations in the radio environment associated with natural and man-made obstructions.

As is well known in the art, each of cells 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present disclosure is not limited to any particular cell configuration.

In one embodiment of the present disclosure, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell. This equipment may include air conditioning units, heating units, electrical supplies, telephone line interfaces and RF transmitters and RF receivers. For the purpose of simplicity and clarity in explaining the operation of the present disclosure, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Alternatively, communication line 131 may be replaced by a wireless backhaul system, such as microwave transceivers. Communication line 131 links each vocoder in the BSC with switch elements in MSC 140. The connections on communication line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the mobile stations in a wireless network and external networks, such as the PSTN or Internet. MSC 140 is well known to those skilled in the art. In some embodiments, communication line 131 may be several different data links where each data link couples one of BS 101, BS 102, or BS 103 to MSC 140.

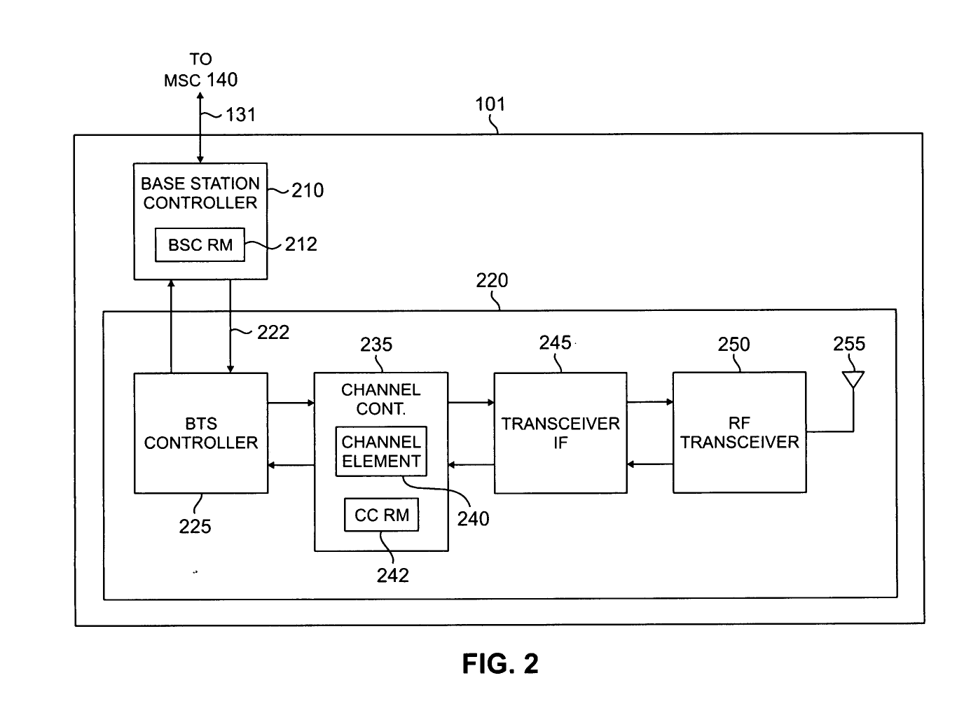

FIG. 2 illustrates exemplary base station 101 in greater detail according to an exemplary embodiment of the present disclosure. Base station 101 comprises base station controller (BSC) 210 and base transceiver station (BTS) 220. Base station controllers and base transceiver stations were described previously in connection with FIG. 1. BSC 210 manages the resources in cell site 121, including BTS 220; in some embodiments, the resources are managed using BSC resource manager (RM) 212, as described in more detail below. BTS 220 comprises BTS controller 225, channel controller 235 (which contains representative channel element 240), transceiver interface (IF) 245, RF transceiver 250, and antenna array 255.

BSC 210 communicates with BTS 220 using multiple transmission lines 222. Transmission lines 222 may be any suitable connection means, including a T1 line, a T3 line, a fiber optic link, a network packet data backbone connection, or any other type of data connection. The connections on transmission lines 222 may transmit analog voice signals or digital voice signals in pulse code modulated (PCM) format, Internet Protocol (IP) format, asynchronous transfer mode (ATM) format, or the like. In some disclosed embodiments, transmission lines 222 are resources managed by BSC RM 212, and calls and other data loads are assigned among transmission lines 222 as described herein.

BTS controller 225 comprises processing circuitry and memory capable of executing an operating program that controls the overall operation of BTS 220 and communicates with BSC 210. Under normal conditions, BTS controller 225 directs the operation of channel controller (CC) 235, which contains a number of channel elements, including channel element 240, that perform bi-directional communications in the forward channel and the reverse channel. A “forward” channel refers to outbound signals from the base station to the mobile station and a “reverse” channel refers to inbound signals from the mobile station to the base station. Transceiver IF 245 transfers the bi-directional channel signals between channel controller 235 and RF transceiver 250. In some embodiments, channel controller (CC) 235 includes channel controller resource manager (RM) 242, used to manage assignment of channel elements 240 as disclosed herein.

Antenna array 255 transmits forward channel signals received from RF transceiver 250 to mobile stations in the coverage area of BS 101. Antenna array 255 also sends to RF transceiver 250 reverse channel signals received from mobile stations in the coverage area of BS 101. In a preferred embodiment of the present disclosure, antenna array 255 is multi-sector antenna, such as a three-sector antenna in which each antenna sector is responsible for transmitting and receiving in a 120 degree arc of coverage area. Additionally, RF transceiver 250 may contain an antenna selection unit to select among different antennas in antenna array 255 during both transmit and receive operations.

A fundamental drawback of conventional resource allocation techniques is that these techniques use only the knowledge of resource availability status, but do not take resource performance into account. Thus, a badly performing resource, such as a malfunctioning transmission line 222 or malfunctioning channel element 240, can severely degrade call performance. In disclosed embodiments, BSC RM 212 and CC RM 242 use resource performance information as part of resource allocation. In some disclosed embodiments, resources managed by BSC RM 212, including call traffic and other data loads for transmission lines 222, are assigned using a performance-based assignment method as described herein. Similarly, in some disclosed embodiments, the call assignments to channel elements 240 are managed by CC RM 242 using a performance-based assignment method as described herein.

In some embodiments, resource allocation includes a “weighted fair allocation” approach. Each resource, such as a transmission lines 222 or channel element 240, is assigned a weight based on its past performance. Resource performance can be computed, for example, every half hour using performance data such as operational measurement (OM) data, known to those of skill in the art. The appropriate resource manager can then allocate resources based on weight assigned to each resource, in addition to other characteristics such as the current loading of each resource. In at least some embodiments, this approach behaves the same as a conventional least-loaded allocation algorithm when all the resources perform at the same level, but adjusts the resource allocations accordingly when resources do not perform at the same level.

By way of example, it is assumed there are two transmission lines 222 from BSC 210 towards BTS 220. Due to some transmission issue, most of the calls on a first one of the transmission lines 222 fail. At the end of one half hour, when BSC RM 212 re-computes resource performance, BSC RM 212 assigns a much lower weight to the first transmission line 222. This, in turn, would result in more number of calls being allocated to the good second transmission line 222, and hence would improve call performance. If the first transmission line 222 continued to perform badly, the weight assigned to it would continue to decrease. Conversely, if the transmission issue is resolved, BCS RM 212 automatically increases the weight of the first transmission line 222 and assigns more calls to it.

In some embodiments, resource allocation includes a quality of service (QOS)-based allocation by considering subscriber QOS requirements during resource allocation. For example, an under-performing resource, such as an underperforming channel element 240, may be allocated by CC RM 242 to a user with low QOS requirements and a user with high QOS requirement is allocated only a high performing resource.

Another example of the advantages of resource allocation according to disclosed embodiments occurs when a channel element 240 is not be able to handle traffic frames properly due to a software problem (e.g., data corruption). In a conventional system, such failures often remain undetected and no alarm is generated. However, all of the calls allocated to channel element 240 fail because channel element 240 cannot decode reverse traffic frames from mobile station 111. In disclosed embodiments, by considering OM data, CC RM 242 assigns a lesser weight to that channel element 240 each time it periodically re-computes resource allocation, so that fewer calls are assigned to that channel element 240 until the software problem is corrected. When the problem is corrected, each time the resource allocation is recomputed, that channel element 240 will be assigned a greater weight until it is as loaded as other comparable channel elements 240.

In various embodiments, the BSC RM 212 can be implemented as a separate controller, processor, or application-specific integrated circuit (ASIC) operating in conjunction with BSC 210, or can be implemented as a software application or routine executed by BSC 210. Similarly, in various embodiments, CC RM 242 can be implemented as a separate controller, processor, or application-specific integrated circuit (ASIC) operating in conjunction with channel controller 235, or can be implemented as a software application or routine executed by channel controller 235. The resource allocation techniques described herein are not limited to use for allocating transmission lines 222 or channel elements 240, but rather can be applied to any dynamically-allocated resources.

Further, in various embodiments, the resource allocation techniques are not limited to application when a new load is needed, e.g., when a new call is assigned or a new mobile station is connected, but rather can be used to dynamically redirect traffic as needed to balance the resource allocation with respect to the OM data, other performance data, or QOS requirements.

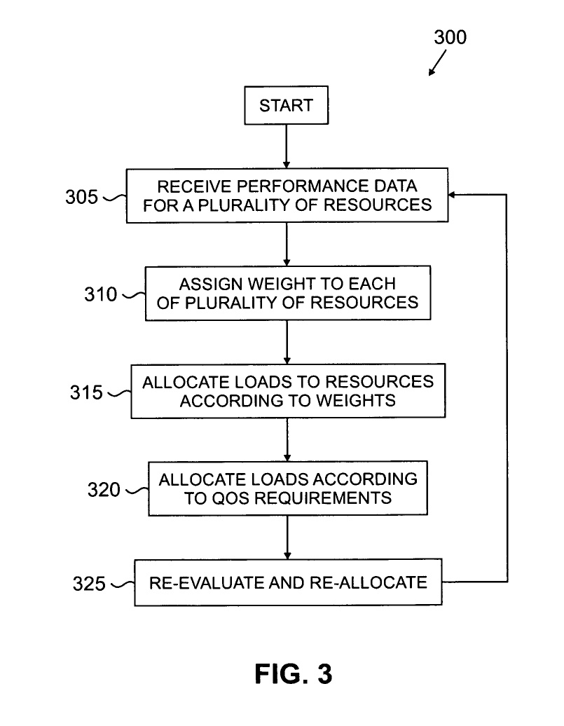

FIG. 3 illustrates a flowchart of a process 300 in accordance with a disclosed embodiment. In various embodiments, this process is performed between various components of a wireless telecommunications network.

A resource manager receives performance data for a plurality of resources (step 305). The resource manager can be a BSC RM 212 managing a plurality of transmission lines 212, or a CC RM 242 managing a plurality of channel elements 240, or another device or element capable of dynamically managing and assigning loads to be serviced by a plurality of resources. The performance data can include operational measurement data, known to those of skill in the art, pertaining to the plurality of resources.

The resource manager assigns a weight to each of the plurality of resources according to the performance data (step 310). For example, the least-performing transmission line 212 or the least-performing channel element 240 can be assigned the least weight.

The resource manager then allocates loads to the plurality of resources at least partially according to the assigned weight (step 315). These loads can include new calls in the case of allocating channel elements 240 or transmission lines 212. In addition to and in combination with the assigned weights, the load allocation can be performed according to other criteria and load-balancing techniques, such as a least-loaded resource allocation technique or a round-robin allocation technique.

In some embodiments, the resource allocation can also be performed at least partially according to a quality-of-service requirement of a load (step 320). In this case, the resource with the weighting indicating the highest performance can be assigned the loads that require the highest quality of service. Periodically, a re-evaluation and re-allocation process can be initiated (step 325, returning to step 305).

Although FIG. 3 illustrates one example of a process 300 for resource allocation in a wireless network, various changes may be made to FIG. 3. For example, one, some, or all of the steps may occur as many times as needed. Also, while shown as a sequence of steps, various steps in FIG. 3 could occur in parallel or in a different order.

In some embodiments, the various functions performed in conjunction with the resource allocation techniques described herein are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. For use in a wireless network, a base station capable of dynamic resource allocation, said base station comprising:
a plurality of transmission lines connecting a base station controller and a base transceiver subsystem; and
a resource manager capable of allocating loads to the plurality of transmission lines based at least partially on performance data of individual ones of the plurality of transmission lines.

2. The base station as set forth in claim 1, wherein said resource manager is implemented in the base station controller.

3. The base station as set forth in claim 1, wherein the resource manager is a software application executed by the base station controller.

4. The base station as set forth in claim 1, wherein the resource manager is further capable of allocating loads to the plurality of transmission lines based at least partially on quality of service requirements of the loads.

5. The base station as set forth in claim 1, wherein the loads are call traffic.

6. The base station as set forth in claim 1, wherein the resource manager is further capable of assigning a weight to individual ones of the plurality of transmission lines according to the performance data.

7. The base station as set forth in claim 1, wherein the resource manager is capable of dynamically reassigning the loads to the plurality of transmission lines according to the performance data.

8. For use in a wireless network, a base transceiver subsystem capable of dynamic resource allocation, said base transceiver subsystem comprising:
a plurality of channel elements for performing bi-directional communications with a mobile station; and
a resource manager capable of allocating loads to the plurality of channel elements based at least partially on performance data of individual ones of the plurality of channel elements.

9. The base transceiver subsystem as set forth in claim 8, wherein said resource manager is implemented in a channel controller.

10. The base transceiver subsystem as set forth in claim 8, wherein the resource manager is a software application executed by a channel controller.

11. The base transceiver subsystem as set forth in claim 8, wherein the resource manager is further capable of allocating loads to the plurality of channel elements based at least partially on quality of service requirements of the loads.

12. The base transceiver subsystem as set forth in claim 8, wherein the loads are call traffic.

13. The base transceiver subsystem as set forth in claim 8, wherein the resource manager is further capable of assigning a weight to individual ones of the plurality of channel elements according to the performance data.

14. The base station as set forth in claim 1, wherein the resource manager is capable of dynamically reassigning the loads to the plurality of channel elements according to the performance data.

15. A network, comprising:
a plurality of resources, each resource capable of servicing at least one load; and
a resource manager capable of dynamically allocating loads to the plurality of resources based at least partially on performance data of individual ones of the plurality of resources.

16. For use in a wireless network, a method of resource allocation, the method comprising the steps of:
receiving performance data for a plurality of resources;
assigning a weight to at least one of the plurality of resources based on the performance data; and
allocating a load to at least one of the plurality of resources according to the assigned weight.

17. The method as set forth in claim 16, further comprising allocating a load to at least one of the plurality of resources according to a quality of service requirement.

18. The method as set forth in claim 16, wherein the resources are channel elements in a wireless network base station.

19. The method as set forth in claim 16, wherein the resources are transmission links in a wireless network.

20. The method as set forth in claim 16, further comprising periodically dynamically reassigning the loads to the plurality of resources according to the performance data.
